(19) United States
(12) Patent Application Publication
(10) Pub. No.: US 2023/0174078 A1
(43) Pub. Date: Jun. 8, 2023

(54) MOTOR VEHICLE DRIVER ASSISTANCE SYSTEM AND METHOD

(71) Applicant: Continental Automotive GmbH, Hannover (DE)

(72) Inventors: Meibin Yu, Tokyo (JP); Nobuto Yoshimura, Setagayaku (JP); Stefan Feick, Bad Soden (DE); Ketan Babar, Frankfurt am Main (DE)

(73) Assignee: Continental Automotive GmbH, Hannover (DE)

(21) Appl. No.: 17/457,557

(22) Filed: Dec. 3, 2021

(51) Int. Cl. B60W 40/13

(52) U.S. Cl. CPC B60W 40/13; B60W 2300/14; B60W 2530/10; B60W 2510/0657; B60W 2520/10; B60W 2520/06; B60W 2520/14; B60W 2520/16; B60W 2552/15; B60W 2552/30

(57) ABSTRACT

A motor vehicle driver assistance system including a vehicular data module configured to derive a trailer weight and a vehicular control parameter determiner configured to determine a parameter value of a vehicular control parameter based on the trailer weight derived.

### TECHNICAL FIELD

The technical field relates generally to a motor vehicle driver assistance system, and more specifically a motor vehicle driver assistance system for a motor vehicle towing a trailer and a corresponding motor vehicle driver assistance method.

### BACKGROUND

A motor vehicle driver assistance system may be used to assist a driver to control a motor vehicle, such as a car or a lorry, whether the motor vehicle is being driven manually, semi-autonomously, or autonomously. For instance, it may be difficult to keep a motor vehicle moving in its lane on a bend, particularly if the motor vehicle is towing a trailer. Hence, it is desirable to provide a reliable motor vehicle driver assistance system in order to assist to control a motor vehicle.

### SUMMARY

According to a first aspect of the disclosure, there is provided a motor vehicle driver assistance system having a vehicular data module configured to derive a trailer weight value and a vehicular control parameter determiner configured to determine a parameter value of a vehicular control parameter based on the trailer weight value derived.

One advantage of the motor vehicle driver assistance system is that it takes a trailer weight value derived into account in order to assist to control a motor vehicle.

Optionally, the vehicular data module is configured to receive engine torque data and to derive the trailer weight value from the engine torque data received.

One advantage of the motor vehicle driver assistance system is that no additional equipment is required because existing equipment in virtually all motor vehicles would be able to provide engine torque data. Hence, the inventiveness of using engine torque data to derive a trailer weight value is made even more evident.

Optionally, the vehicular data module is configured to receive vehicular speed data and to derive the trailer weight value by correlating the engine torque data received with the vehicular speed data received.

One advantage of the motor vehicle driver assistance system is that no additional equipment is required because existing equipment in virtually all motor vehicles would be able to provide vehicular speed data. Hence, the inventiveness of using vehicular speed data to derive a trailer weight value is made even more evident.

Optionally, the vehicular control parameter comprises a steering angle of a motor vehicle.

One advantage of the motor vehicle driver assistance system is that it is able to assist to control a motor vehicle by determining a suitable steering angle.

The motor vehicle driver assistance system may further include a vehicular category classifier configured to classify a motor vehicle into one of a plurality of trailer categories based on the trailer weight value derived.

One advantage of the motor vehicle driver assistance system is that it is able to assist to control a motor vehicle by quickly and conveniently classifying the motor vehicle into one of a plurality of trailer categories based on a trailer weight value derived.

Optionally, the vehicular control parameter determiner is configured to determine the parameter value of the vehicular control parameter based on the one of the plurality of trailer categories that the motor vehicle is classified into.

One advantage of the motor vehicle driver assistance system is that it is able to assist to control a motor vehicle by quickly and conveniently determining the parameter value of the vehicular control parameter based on the one of the plurality of trailer categories that the motor vehicle is classified into.

The motor vehicle driver assistance system may further include a vehicular control parameter calibrator configured to fine-tune the vehicular control parameter.

One advantage of the motor vehicle driver assistance system is that it is able to continually improve the control of a motor vehicle by fine-tuning a vehicular control parameter.

Optionally, the vehicular data module is configured to receive vehicular data, and the vehicular control parameter calibrator is configured to fine-tune the vehicular control parameter based on the vehicular data received.

One advantage of the motor vehicle driver assistance system is that it is able to continually improve the control of a motor vehicle by fine-tuning a vehicular control parameter based on vehicular data received.

Optionally, the vehicular control parameter calibrator is configured to fine-tune the vehicular control parameter based on the vehicular data comprising at least one of engine torque data, steering angle data, yaw rate data, row rate data, pitch rate data, row axis direction acceleration data, pitch axis direction acceleration data, row axis direction velocity data, pitch axis direction velocity data, vehicular speed data, trailer dimensions data, road pitch axis incline angle data, road row axis incline angle data or lane curvature data.

One advantage of the motor vehicle driver assistance system is that it is able to continually improve the control of a motor vehicle by fine-tuning a vehicular control parameter based on at least one of engine torque data, steering angle data, yaw rate data, row rate data, pitch rate data, row axis direction acceleration data, pitch axis direction acceleration data, row axis direction velocity data, pitch axis direction velocity data, vehicular speed data, trailer dimensions data, road pitch axis incline angle data, road row axis incline angle data or lane curvature data.

The motor vehicle driver assistance system may further comprise a vehicular controller configured to control a motor vehicle using the parameter value of the vehicular control parameter determined.

One advantage of the motor vehicle driver assistance system is that it is able to assist to control a motor vehicle.

A motor vehicle may include the motor vehicle driver assistance system.

Any feature or step disclosed in the context of the first aspect of the invention may also be used, to the extent possible, in combination with and/or in the context of other aspects of the invention, and in the inventions generally. In addition, any feature or step disclosed in the context of any other aspect of the invention may also be used, to the extent possible, in combination with and/or in the context of the first aspect of the invention, and in the inventions generally.

According to a second aspect of the disclosure, there is provided a motor vehicle driver assistance system having a vehicular data module configured to derive a trailer weight value. The vehicular data module is configured to receive engine torque data and to derive the trailer weight value from the engine torque data received. The vehicular data module is also configured to receive vehicular speed data and to derive the trailer weight value by correlating the engine torque data received with the vehicular speed data received. The vehicular control parameter includes a steering angle of a motor vehicle. A vehicular category classifier is configured to classify the motor vehicle into one of a plurality of trailer categories based on the trailer weight value derived. A vehicular control parameter determiner is configured to determine a parameter value of a vehicular control parameter based on the trailer weight value derived. The vehicular control parameter determiner is configured to determine the parameter value of the vehicular control parameter based on the one of the plurality of trailer categories that the motor vehicle is classified into. A vehicular control parameter calibrator is configured to fine-tune the vehicular control parameter. The vehicular data module is configured to receive vehicular data and the vehicular control parameter calibrator is configured to fine-tune the vehicular control parameter based on the vehicular data received. The vehicular control parameter calibrator is configured to fine-tune the vehicular control parameter based on the vehicular data including at least one of engine torque data, steering angle data, yaw rate data, row rate data, pitch rate data, row axis direction acceleration data, pitch axis direction acceleration data, row axis direction velocity data, pitch axis direction velocity data, the vehicular speed data, trailer dimensions data, road pitch axis incline angle data, road row axis incline angle data or lane curvature data. A vehicular controller is configured to control a motor vehicle using the parameter value of the vehicular control parameter determined.

One advantage of the motor vehicle driver assistance system is that it takes a trailer weight value derived into account in order to assist to control a motor vehicle.

Any feature or step disclosed in the context of the second aspect of the disclosure may also be used, to the extent possible, in combination with and/or in the context of other aspects of the invention, and in the inventions generally. In addition, any feature or step disclosed in the context of any other aspect of the disclosure may also be used, to the extent possible, in combination with and/or in the context of the second aspect of the disclosure, and in the disclosures generally.

According to a third aspect of the disclosure, there is provided a computer-implemented motor vehicle driver assistance method including deriving a trailer weight value and determining a parameter value of a vehicular control parameter based on the trailer weight value derived.

One advantage of the motor vehicle driver assistance method is that it takes a trailer weight value derived into account in order to assist to control a motor vehicle.

The motor vehicle driver assistance method may further include receiving engine torque data, wherein the act of deriving the trailer weight value includes the act of deriving the trailer weight value from the engine torque data received.

One advantage of the motor vehicle driver assistance method is that no additional equipment is required because existing equipment in virtually all motor vehicles would be able to provide engine torque data. Hence, the inventiveness of using engine torque data to derive a trailer weight value is made even more evident.

The motor vehicle driver assistance method may further include receiving vehicular speed data, wherein deriving the trailer weight value from the engine torque data received includes correlating the engine torque data received with the vehicular speed data received.

One advantage of the motor vehicle driver assistance method is that no additional equipment is required because existing equipment in virtually all motor vehicles would be able to provide vehicular speed data. Hence, the inventiveness of using vehicular speed data to derive a trailer weight value is made even more evident.

Optionally, the act of determining the parameter value of the vehicular control parameter comprises the act of determining the parameter value of the vehicular control parameter comprising a steering angle of a motor vehicle.

One advantage of the motor vehicle driver assistance method is that it is able to assist to control a motor vehicle by determining a suitable steering angle.

The motor vehicle driver assistance method may further include classifying a motor vehicle into one of a plurality of trailer categories based on the trailer weight value derived.

One advantage of the motor vehicle driver assistance method is that it is able to assist to control a motor vehicle by quickly and conveniently classifying the motor vehicle into one of a plurality of trailer categories based on a trailer weight value derived.

Optionally, the act of determining the parameter value of the vehicular control parameter comprises the act of determining the parameter value of the vehicular control parameter based on the one of the plurality of trailer categories that the motor vehicle is classified into.

One advantage of the motor vehicle driver assistance method is that it is able to assist to control a motor vehicle by quickly and conveniently determining the parameter value of the vehicular control parameter based on the one of the plurality of trailer categories that the motor vehicle is classified into.

The motor vehicle driver assistance method may further include fine-tuning the vehicular control parameter.

One advantage of the motor vehicle driver assistance method is that it is able to continually improve the control of a motor vehicle by fine-tuning a vehicular control parameter.

The motor vehicle driver assistance method may further include receiving vehicular data, wherein the act of fine-tuning the vehicular control parameter comprises the act of fine-tuning the vehicular control parameter based on the vehicular data received.

One advantage of the motor vehicle driver assistance method is that it is able to continually improve the control of a motor vehicle by fine-tuning a vehicular control parameter based on vehicular data received.

Optionally, the act of fine-tuning the vehicular control parameter based on the vehicular data received includes fine-tuning the vehicular control parameter based on the vehicular data comprising at least one of engine torque data, steering angle data, yaw rate data, row rate data, pitch rate data, row axis direction acceleration data, pitch axis direction acceleration data, row axis direction velocity data, pitch axis direction velocity data, vehicular speed data, trailer dimensions data, road pitch axis incline angle data, road row axis incline angle data or lane curvature data.

One advantage of the motor vehicle driver assistance method is that it is able to continually improve the control of a motor vehicle by fine-tuning a vehicular control parameter based on at least one of engine torque data, steering angle data, yaw rate data, row rate data, pitch rate data, row axis direction acceleration data, pitch axis direction acceleration data, row axis direction velocity data, pitch axis direction velocity data, vehicular speed data, trailer dimensions data, road pitch axis incline angle data, road row axis incline angle data or lane curvature data.

The motor vehicle driver assistance method may further include controlling a motor vehicle using the parameter value of the vehicular control parameter determined.

One advantage of the motor vehicle driver assistance method is that it is able to assist to control a motor vehicle.

Any feature or step disclosed in the context of the third aspect of the disclosure may also be used, to the extent possible, in combination with and/or in the context of other aspects of the invention, and in the inventions generally. In addition, any feature or step disclosed in the context of any other aspect of the disclosure may also be used, to the extent possible, in combination with and/or in the context of the third aspect of the disclosure, and in the disclosures generally.

As used in this summary, in the description below, in the claims below, and in the accompanying drawings, reference is made to particular features (including method steps). It is to be understood that the disclosure in this specification includes all possible combinations of such particular features. For example, where a particular feature is disclosed in the context of a particular aspect or embodiment, or a particular claim, that feature may also be used, to the extent possible, in combination with and/or in the context of other particular aspects and embodiments of the disclosure, and in the disclosures generally.

As used in this summary, in the description below, in the claims below, and in the accompanying drawings, where reference is made herein to a method comprising two or more defined steps or acts, the defined steps or acts may be carried out in any order or simultaneously (except where the context excludes that possibility), and the method may include one or more other steps or acts which are carried out before any of the defined steps or acts, between two of the defined steps or acts, or after all the defined steps or acts (except where the context excludes that possibility).

As used in this summary, in the description below, in the claims below, and in the accompanying drawings, the terms “includes,” “comprises,” and grammatical equivalents thereof are used herein to mean that other components, ingredients, steps, et cetera are optionally present. For example, an article “comprising” (or “which comprises”) components A, B, and C may consist of (that is, contain only) components A, B, and C, or may contain not only components A, B, and C but also one or more other components.

As used in this summary, in the description below, in the claims below, and in the accompanying drawings, the term “at least” followed by a number is used in to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending on the variable being defined). For example, “at most 4” means 4 or less than 4, and “at most 40%” means 40% or less than 40%. When, in this specification, a range is given as “(a first number) to (a second number)” or “(a first number)-(a second number)”, this means a range whose lower limit is the first number and whose upper limit is the second number. For example, 25 to 100 mm means a range whose lower limit is 25 mm, and whose upper limit is 100 mm.

As used in this summary, in the description below, in the claims below, and in the accompanying drawings, the term “vehicle” means a transportation device suitable for transporting humans or goods from a first location to a second location. In addition, a vehicle comprises the transportation device itself, such as a motor vehicle, or a component connected to the vehicle, such as a trailer or a sidecar.

As used in this summary, in the description below, in the claims below, and in the accompanying drawings, the term “motor vehicle” means a road vehicle driven by an engine.

As used in this summary, in the description below, in the claims below, and in the accompanying drawings, the term “trailer” means an object configured to be pulled by a vehicle. A trailer may be a container or a vehicle.

As used in this summary, in the description below, in the claims below, and in the accompanying drawings, the term “tow” means to pull an object with a vehicle.

As used in this summary, in the description below, in the claims below, and in the accompanying drawings, the term “vehicular control parameter” means a variable or factor related to the control of a vehicle, for instance, a steering angle of the vehicle or a gear position of a vehicle.

As used in this summary, in the description below, in the claims below, and in the accompanying drawings, the term “trailer weight value” means a numerical quantity that denotes the weight of a trailer.

As used in this summary, in the description below, in the claims below, and in the accompanying drawings, the term “image” means a two-dimensional or three-dimensional picture of an actual location in the real world. An image may be captured by one single image capturing device, such as a camera or a LiDAR sensor, or created by fusing data from several devices, such as ultrasonic sensor, LiDAR sensor, radar sensor or camera.

As used in this summary, in the description below, in the claims below, and in the accompanying drawings, the term “vehicular camera” means a camera that is suitable to be used with a vehicle, such as a motor vehicle, a trailer or a sidecar. A vehicular camera may be installed in the interior of the vehicle, such as being attached to a rear-view mirror, or be mounted on an exterior portion of the vehicle, such as being affixed to a wing mirror.

As used in this summary, in the description below, in the claims below, and in the accompanying drawings, the term “motor vehicle driver assistance system” means a system configured to help or support a driver or a driving system to drive a vehicle. A motor vehicle driver assistance system may be carried out by software, hardware or a combination of software and hardware.

As used in this summary, in the description below, in the claims below, and in the accompanying drawings, the term “motor vehicle driver assistance method” means a method that is able to help or support a driver or a driving system to drive a vehicle. A motor vehicle driver assistance method may be carried out by software, hardware or a combination of software and hardware.

As used in this summary, in the description below, in the claims below, and in the accompanying drawings, the term “row axis” means an axis through a body of a vehicle between its rear and its front, generally along a direction of travel. A row axis is normally a horizontal axis that is orthogonal to both a pitch axis and a yaw axis of a vehicle. Hence, a vehicle travelling in a forward direction may, for example, move or rotate about a row axis of the vehicle when the vehicle is moving on a bend, such that one side, for instance, the left side, of the vehicle moves downwards about its row axis, whilst another side, for instance, the right side, of the vehicle moves upwards about its row axis.

As used in this summary, in the description below, in the claims below, and in the accompanying drawings, the term “pitch axis” means an axis through a body of a vehicle between its left and its right, generally orthogonal to a direction of travel. A pitch axis is normally a horizontal axis that is orthogonal to both a row axis and a yaw axis of a vehicle. Hence, a vehicle travelling in a forward direction may, for example, move or rotate about a pitch axis of the vehicle when the vehicle is accelerating or decelerating, such that one side, for instance, the front, of the vehicle moves upwards about its pitch axis, whist than another side, for instance, the rear, of the vehicle moves downwards about its pitch axis.

As used in this summary, in the description below, in the claims below, and in the accompanying drawings, the term “yaw axis” means an axis orthogonal to both a row axis and a pitch axis of a vehicle, and it is normally vertical.

As used in this summary, in the description below, in the claims below, and in the accompanying drawings, the term “steering angle” means the angle between a row axis of a motor vehicle and a direction of a steered wheel of the motor vehicle.

As used in this summary, in the description below, in the claims below, and in the accompanying drawings, the term “fine-tune” means to make changes to something in order to try to improve it.

As used in this summary, in the description below, in the claims below, and in the accompanying drawings, the term “vehicular data” means data related to a vehicle. Vehicular data may comprise at least one of engine torque data, steering angle data, yaw rate data, row rate data, pitch rate data, row axis direction acceleration data, pitch axis direction acceleration data, row axis direction velocity data, pitch axis direction velocity data, vehicular speed data, trailer dimensions data, road pitch axis incline angle data, road row axis incline angle data or lane curvature data.

As used in this summary, in the description below, in the claims below, and in the accompanying drawings, the term “row axis direction acceleration” means a rate of change of velocity of a vehicle along its row axis.

As used in this summary, in the description below, in the claims below, and in the accompanying drawings, the term “pitch axis direction acceleration” means a rate of change of velocity of a vehicle along its pitch axis.

As used in this summary, in the description below, in the claims below, and in the accompanying drawings, the term “road pitch axis incline angle” means an angle of a slope a road along a pitch axis of a vehicle.

As used in this summary, in the description below, in the claims below, and in the accompanying drawings, the term “road row axis incline angle” means an angle of a slope a road along a row axis of a vehicle.

As used in this summary, in the description below, in the claims below, and in the accompanying drawings, the term “vehicular camera” means a camera that is suitable to be used with a vehicle, such as a motor vehicle, a trailer or a sidecar. A vehicular camera may be installed in the interior of the vehicle, such as being attached to a rear-view mirror, or be mounted on an exterior portion of the vehicle, such as being affixed to a wing mirror.

As used in this summary, in the description below, in the claims below, and in the accompanying drawings, the term “volatile memory” means any type of computer memory where the contents of the memory are lost if there is no power to the computer. Random-access memory (RAM) is an example of a type of volatile memory. As used in the summary above, in this description, in the claims below, and in the accompanying drawings, the term “nonvolatile memory” or the term “non-transitory computer-readable medium” means any type of computer memory where the contents of the memory are retained even if there is no power to the computer. Hard disk and solid-state drive (SSD) are examples of types of nonvolatile memory or non-transitory computer-readable medium.

As used in this summary, in the description below, in the claims below, and in the accompanying drawings, the term “processor” means a computer component that is configured to perform calculations, make decisions, execute instructions, process data or control other computer components. Central processing unit (CPU) and graphics processing unit (GPU) are examples of types of processor.

### BRIEF DESCRIPTION OF THE DRAWINGS

These and other features, aspects, and advantages will become better understood with regard to the following description, appended claims, and accompanying drawings where:

FIG. 1 shows a motor vehicle driver assistance system;

FIG. 2 shows a motor vehicle comprising the motor vehicle driver assistance system of FIG. 1; and

FIG. 3 shows a diagram for a motor vehicle driver assistance method.

In the drawings, like parts are denoted by like reference numerals.

### DESCRIPTION

In the summary above, in this description, in the claims below, and in the accompanying drawings, reference is made to particular features (including method steps) of the invention. It is to be understood that the disclosure in this specification includes all possible combinations of such particular features. For example, where a particular feature is disclosed in the context of a particular aspect or embodiment, or a particular claim, that feature may also be used, to the extent possible, in combination with and/or in the context of other particular aspects and embodiments, and in the disclosures generally.

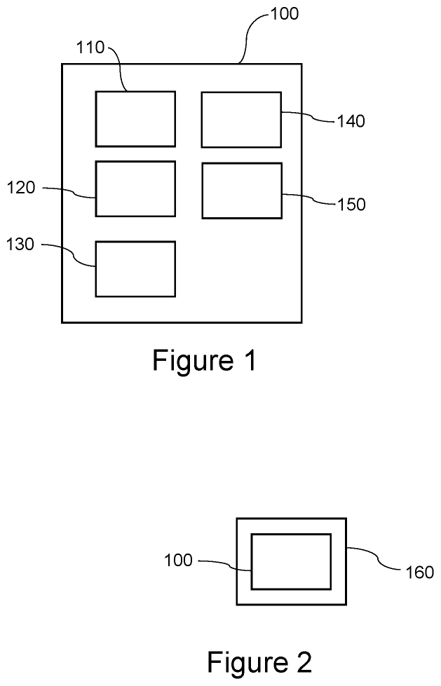

FIG. 1 shows a motor vehicle driver assistance system 100 that may include a vehicular data module 110, a vehicular category classifier 120, a vehicular control parameter determiner 130, a vehicular control parameter calibrator 140 and a vehicular controller 150. The motor vehicle driver assistance system 100 may comprise hardware, such as at least one processor, volatile memory, and/or non-volatile memory, software including instructions executable by a processor, or a combination of software and hardware.

The vehicular data module 110 is configured to derive a trailer weight value. The vehicular data module 110 may be configured to receive engine torque data and to derive a trailer weight value from the engine torque data received. The vehicular data module 110 may also be configured to receive vehicular speed data and engine torque data, and to derive a trailer weight value by correlating the engine torque data received with the vehicular speed data received. Further, the vehicular data module may be configured to receive vehicular data. The vehicular data module 110 may comprise hardware, such as at least one processor, volatile memory, and/or non-volatile memory, software comprising instructions executable by a processor, or a combination of software and hardware.

Vehicular data may include at least one of engine torque data, steering angle data, yaw rate data, row rate data, pitch rate data, row axis direction acceleration data, pitch axis direction acceleration data, row axis direction velocity data, pitch axis direction velocity data, vehicular speed data, trailer dimensions data, road pitch axis incline angle data, road row axis incline angle data or lane curvature data.

The vehicular category classifier 120 is configured to classify a motor vehicle into one of a plurality of trailer categories based on a trailer weight value. The vehicular category classifier 120 may be configured to receive information from a trailer connection sensor that detects whether a trailer is connected to a motor vehicle. The vehicular category classifier 120 may comprise hardware, such as at least one processor, volatile memory, and/or nonvolatile memory, software comprising instructions executable by a processor, or a combination of software and hardware.

A trailer category may, for example, be “No Trailer”, “Light Trailer”, “Average Trailer” or “Heavy Trailer”. Each category may comprise at least one predetermined parameter value for at least one vehicular control parameter. For instance, if a motor vehicle is classified under an “Average Trailer” category, the lane curvature detected is 10 meters radius and the vehicular speed is 30 km/h, then a vehicular control parameter, for example, a steering angle of the motor vehicle, may comprise a parameter value of 20 degrees.

The vehicular control parameter determiner 130 is configured to determine a parameter value of a vehicular control parameter based on a trailer weight value. The vehicular control parameter determiner 130 may be configured to determine a value of a vehicular control parameter based on one of a plurality of trailer categories that a motor vehicle is classified into. The vehicular control parameter determiner 130 may comprise hardware, such as at least one processor, volatile memory, and/or non-volatile memory, software comprising instructions executable by a processor, or a combination of software and hardware.

The vehicular control parameter calibrator 140 is configured to fine-tune a vehicular control parameter. The vehicular control parameter calibrator 140 may be configured to fine-tune a vehicular control parameter based on vehicular data. For instance, if vehicular data received indicate a non-zero pitch axis direction acceleration, suggesting that a motor vehicle is skidding sideways, the vehicular control parameter calibrator 140 may fine-tune a vehicular control parameter, for example, a steering angle, by changing its parameter value from 20 degrees to 15 degrees. The vehicular control parameter calibrator 140 may comprise hardware, such as at least one processor, volatile memory, and/or non-volatile memory, software comprising instructions executable by a processor, or a combination of software and hardware.

The vehicular controller 150 is configured to control a motor vehicle using a value of a vehicular control parameter. The vehicular controller 150 may cause a physical change to a vehicle, for example, a change in a steering angle, a shift into a different gear or an application of brakes. The vehicular controller 150 may comprise hardware, such as at least one processor, volatile memory, and/or non-volatile memory, software comprising instructions executable by a processor, or a combination of software and hardware.

FIG. 2 shows a motor vehicle 160 comprising the motor vehicle driver assistance system 100. The motor vehicle 160 may be a car.

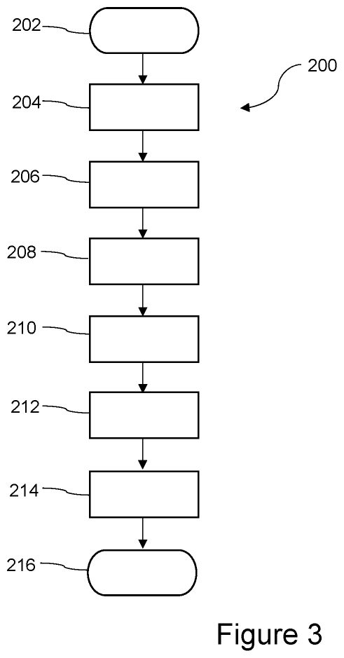

FIG. 3 shows a diagram for a motor vehicle driver assistance method 200 using the motor vehicle driver assistance system 100. The steps or acts of the motor vehicle driver assistance method 200 may be performed by at least one processor, for instance, by the at least one processor executing instructions stored on at least one non-transitory computer-readable medium.

At step 202, the motor vehicle driver assistance method 200 begins, for example, when a motor vehicle 160 is started or when the motor vehicle 160 is driven off from rest. At step 204, a trailer weight value is derived. The trailer weight value may be obtained directly, such as, by weighing a trailer and providing the trailer weight value to the motor vehicle driver assistance system 100. The trailer weight value may also be obtained indirectly, for example, by estimation. When the trailer is connected to the motor vehicle 160, the weight of the trailer may be estimated by using the engine torque data. For instance, more engine torque would be required to drive off the motor vehicle 160 when it is towing a heavier trailer compared to when it is towing a lighter trailer. In addition, more engine torque would be required to drive the motor vehicle 160 at a certain speed when it is towing a heavier trailer compared to when it is towing a lighter trailer.

Then at step 206, the motor vehicle 160 is classified into one of a plurality of trailer categories based on the trailer weight value. Subsequently, at step 208, at least one parameter value of at least one vehicular control parameter is determined based on the trailer category the motor vehicle 160 is classified into.

Thereafter, at step 210, vehicular data are received. Then, at step 212, the at least one vehicular control parameter is fine-tuned based on the vehicular data received. Subsequently, at step 214, the motor vehicle 160 is controlled using the parameter value of the vehicular control parameter.

Optionally, step 210, step 212 and step 214 may be iteratively performed until the motor vehicle driver assistance method 200 ends.

Finally, at step 216, the motor vehicle driver assistance method 200 ends, for example, when the ignition is turned off.

Although the invention has been described in considerable detail with reference to certain embodiments or aspects, other embodiments or aspects are possible.

For example, at step 206, the motor vehicle driver assistance system 100 receives information on whether a trailer is connected to the motor vehicle 160, for example, by a trailer connection sensor.

Therefore, the spirit and scope of the appended claims should not be limited to the description of the embodiments contained herein.

All features disclosed in this specification (including the appended claims, abstract, and accompanying drawings) may be replaced by alternative features serving the same, equivalent, or similar purpose, unless expressly stated otherwise. Thus, unless expressly stated otherwise, each feature disclosed is one example only of a generic series of equivalent or similar features.

1. A motor vehicle driver assistance system comprising:
a vehicular data module configured to derive a trailer weight value; and
a vehicular control parameter determiner configured to determine a parameter value of a vehicular control parameter based on the trailer weight value derived.

2. The motor vehicle driver assistance system as in claim 1, wherein the vehicular data module is configured to receive engine torque data and to derive the trailer weight value from the engine torque data received.

3. The motor vehicle driver assistance system as in claim 2, wherein the vehicular data module is configured to receive vehicular speed data and to derive the trailer weight value by correlating the engine torque data received with the vehicular speed data received.

4. The motor vehicle driver assistance system as in claim 1, wherein the vehicular control parameter comprises a steering angle of a motor vehicle.

5. The motor vehicle driver assistance system as in claim 1, further comprising a vehicular category classifier configured to classify a motor vehicle into one of a plurality of trailer categories based on the trailer weight value derived.

6. The motor vehicle driver assistance system as in claim 5, wherein the vehicular control parameter determiner is configured to determine the parameter value of the vehicular control parameter based on the one of the plurality of trailer categories that the motor vehicle is classified into.

7. The motor vehicle driver assistance system as in claim 1, further comprising a vehicular control parameter calibrator configured to fine-tune the vehicular control parameter.

8. The motor vehicle driver assistance system as in claim 7, wherein the vehicular data module is configured to receive vehicular data, and the vehicular control parameter calibrator is configured to fine-tune the vehicular control parameter based on the vehicular data received.

9. The motor vehicle driver assistance system as in claim 8, wherein the vehicular control parameter calibrator is configured to fine-tune the vehicular control parameter based on the vehicular data comprising at least one of engine torque data, steering angle data, yaw rate data, row rate data, pitch rate data, row axis direction acceleration data, pitch axis direction acceleration data, row axis direction velocity data, pitch axis direction velocity data, vehicular speed data, trailer dimensions data, road pitch axis incline angle data, road row axis incline angle data or lane curvature data.

10. The motor vehicle driver assistance system as in claim 1, further comprising a vehicular controller configured to control a motor vehicle using the parameter value of the vehicular control parameter determined.

11. (canceled)

12. A motor vehicle driver assistance system comprising:
a vehicular data module configured to derive a trailer weight value;
wherein the vehicular data module is configured to receive engine torque data and to derive the trailer weight value from the engine torque data received;
wherein the vehicular data module is configured to receive vehicular speed data and to derive the trailer weight value by correlating the engine torque data received with the vehicular speed data received;
wherein the vehicular control parameter comprises a steering angle of a motor vehicle;
a vehicular category classifier configured to classify the motor vehicle into one of a plurality of trailer categories based on the trailer weight value derived;
a vehicular control parameter determiner configured to determine a parameter value of a vehicular control parameter based on the trailer weight value derived;
wherein the vehicular control parameter determiner is configured to determine the parameter value of the vehicular control parameter based on the one of the plurality of trailer categories that the motor vehicle is classified into;
a vehicular control parameter calibrator configured to fine-tune the vehicular control parameter;
wherein the vehicular data module is configured to receive vehicular data, and the vehicular control parameter calibrator is configured to fine-tune the vehicular control parameter based on the vehicular data received;
wherein the vehicular control parameter calibrator is configured to fine-tune the vehicular control parameter based on the vehicular data comprising at least one of engine torque data, steering angle data, yaw rate data, row rate data, pitch rate data, row axis direction acceleration data, pitch axis direction acceleration data, row axis direction velocity data, pitch axis direction velocity data, the vehicular speed data, trailer dimensions data, road pitch axis incline angle data, road row axis incline angle data or lane curvature data; and
a vehicular controller configured to control a motor vehicle using the parameter value of the vehicular control parameter determined.

13. A computer-implemented motor vehicle driver assistance method comprising the acts of:
deriving a trailer weight value; and
determining a parameter value of a vehicular control parameter based on the trailer weight value derived.

14. The computer-implemented motor vehicle driver assistance method as in claim 13, further comprising the act of receiving engine torque data, wherein the act of deriving the trailer weight value comprises the act of deriving the trailer weight value from the engine torque data received.

15. The computer-implemented motor vehicle driver assistance method as in claim 14, further comprising the act of receiving vehicular speed data, wherein the act of deriving the trailer weight value from the engine torque data received comprises the act of correlating the engine torque data received with the vehicular speed data received.

16. The computer-implemented motor vehicle driver assistance method as in claim 13, wherein the act of determining the parameter value of the vehicular control parameter comprises the act of determining the parameter value of the vehicular control parameter comprising a steering angle of a motor vehicle.

17. The computer-implemented motor vehicle driver assistance method as in claim 13, further comprising the act of classifying a motor vehicle into one of a plurality of trailer categories based on the trailer weight value derived.

18. The computer-implemented motor vehicle driver assistance method as in claim 17, wherein the act of determining the parameter value of the vehicular control parameter comprises the act of determining the parameter value of the vehicular control parameter based on the one of the plurality of trailer categories that the motor vehicle is classified into.

19. The computer-implemented motor vehicle driver assistance method as in claim 13, further comprising the act of fine-tuning the vehicular control parameter.

20. The computer-implemented motor vehicle driver assistance method as in claim 13, further comprising the act of controlling a motor vehicle using the parameter value of the vehicular control parameter determined.
